(19) United States
(12) Patent Application Publication
(10) Pub. No.: US 2017/0053341 A1
(43) Pub. Date: Feb. 23, 2017

(54) DISPOSAL SYSTEM AND METHOD FOR REORDERING GOODS

(71) Applicant: CURO GmbH, Widen (DE)

(72) Inventors: Harald Buchmann, Bindlach (DE); Guido Kenzlers, Bayreuth (DE)

(21) Appl. No.: 14/831,251

(22) Filed: Aug. 20, 2015

(51) Int. Cl. G06Q 30/06; G06Q 10/08; B65F 1/14

(52) U.S. Cl. CPC G06Q 30/0635; B65F 1/1484; G06Q 10/087

(57) ABSTRACT

A disposal system is provided that comprises a disposal bin 1 having at least one receiving space 10 for receiving articles 30, especially packages or items, which are provided with a transponder 31, as well as a computing device 40 having a memory unit (41) for storing an inventory list, a read-out device 21 connected to the computing device 40 for reading data, especially identification data that is stored on the transponders 31, wherein the read-out device 21 is configured and arranged at the disposal bin 1 such that the data on the transponders 31, which are attached to the articles 30 deposited in the disposal bin 1 are readable, wherein the computing device 40 is configured such that it updates the inventory list stored in the memory unit 41 based on data read by the reading device 21. Furthermore, a method for reordering goods is provided.

The invention relates to a disposal system, as well as a method for reordering goods.

Many consumer goods such as for example staple food, detergents or cleaning agents are essential in households and are hence frequently consumed.

The problem arises that the stock of goods must be restocked as instantaneously as possible, so that no shortage in providing these goods will occur. It hence is desirable to provide the consumers with a system for reordering goods as uncomplicated as possible.

Generally, goods have identification means such as barcodes or RFID tags on the package, enabling automated detection.

For this purpose, the online supplier Amazon introduces an apparatus, which is provided with a barcode scanner. With this scanner, goods that are to be ordered may be detected and identified by way of their barcode, and by way of these read information an order of the scanned goods will be sent to the supplier via a Web service.

However, this solution is considered as being disadvantageous. It is up to the consumer to identify goods before their consumption, which may easily be missed. Moreover, the ordering procedure is required to be initiated by manually scanning a barcode, which puts additional effort on the user.

In view of the situation represented above, it is an object of the present invention to simplify the detection of the inventory of goods in a household.

Furthermore, it is another object of the present invention to provide a system for reordering goods that compared to prior art is characterized by a simplified ordering procedure and in which the consumer is not required to initiate the ordering procedure before the goods are actually used up.

Especially, the object will be solved by a disposal system comprising:

a disposal bin having at least one receiving space for receiving articles, especially packages or items, which are provided with a transponder,

a computing device having a memory unit for storing an inventory list,

a read-out device connected to the computing device for reading data, in particular identification data that is stored on the transponders,

wherein the read-out device is arranged at the disposal bin and is configured such that the data on the transponders that are attached to the articles introduced into the disposal bin are readable,

wherein the computing device is configured such that it updates the inventory list stored in the memory unit based on data read by the reading device.

An essential aspect of the invention resides in that reading identification data and hence updating the inventory list is done automatically, and is done at a point of time, where the respective article is disposed. Thus, the inventory list contains those articles that were disposed, and with this, automatically matches the consumed items that demand reordering. The inventory list can identify those articles that are in the disposal bin.

In one embodiment, the disposal bin comprises a receiving space and the read-out device is configured such that all transponders located in the receiving space are readable. This enables complete identification of all articles that are in the receiving space at any time. In this way, update of the inventory list may be performed in a most reliably manner.

In an (other) embodiment the disposal bin has an opening, at which and/or surrounding which the read-out device is arranged such that transponders are readable upon depositing articles into the disposal bin. The read-out device may define a reading zone, where transponders are read. With this, the read-out procedure is simplified in that at all times only one single transponder is required to be read. Thus, transponders may be read on deposited articles instantaneously during disposal.

In an (other) embodiment, the reading zone is defined by a movable receiving element for receiving the articles that is movable such that in an open position an article is insertable into the movable receiving element and the article received therein, in a closing or discharge position, is insertable into the at least one receiving space. The movable receiving element may for example be configured as a drawer, into which the article to be disposed of is deposited. The read-out device is configured such that it reads the transponder at the article located in the reading zone upon moving the movable receiving element. In the closing or discharge position the article is then transferred into the at least one receiving space. In a preferred embodiment, the drawer may be produced of metal. This simplifies selectively reading the transponders in the drawer, since the metal drawer shields the transponders located in the receiving space against the read-out device, which assures that only the transponder of the article currently disposed of is read.

In an (other) embodiment, the read-out device comprises an activation unit, which is configured to activate the read-out device. With the activation unit it is possible to activate the read-out device only if it is truly required, thus reducing energy consumption of the disposal system.

In one possible embodiment, the activation unit is arranged as detecting the opening and is configured as a motion-sensitive element such that the read-out device is activated, when an article passes the motion-sensitive element in the disposal bin. It is thus not required for a user to manually activate the read-out device if an article is thrown into the disposal bin. In one embodiment, the motion-sensitive element is for example configured as a motion sensor or a light barrier at the upper end of the reading zone. This represents a technically easy-to-realize configuration of the motion-sensitive element.

In one possible embodiment, the disposal system further comprises an actuator for releasing a/the opening that is operatively coupled with the activation unit such that the read-out device is activated when the actuator is operated. This is advantageous, since for disposal of articles, the opening of the disposal bin is required to be released, i.e. the user is required to operate the actuator anyway.

In an (other) embodiment, the disposal bin comprises at least two receiving spaces as well as an device for selectively assigning the deposited article that is configured such that the article is assignable to and is introducible into exactly one of the receiving spaces, depending on the information read from the transponder. The apparatus may mechanically transfer the article into the assigned receiving space.

By way of this configuration, the reading procedure may simultaneously be used for performing automated waste segregation by using the information stored on the transponder to assign the articles disposed of to specific receiving spaces. Thus, for example recyclable packaging materials may be identified in packages to be disposed of by way of the information stored on the transponder and may be appropriately sorted upon disposal. It is furthermore possible that the transponders contain information on valuable components of articles to be disposed of, such as for example rare earth metals. Articles having valuable components may then be sorted during disposal immediately into dedicated receiving spaces and may be segregated from the household garbage devoid of valuable components. This enables separate recycling of valuable waste components. Waste having valuable components, segregated in this manner may occasionally be sold, which means an appropriate financial gain.

It is furthermore possible, that the read-out device and the computing device are wired and/or are connected via short-range communication (short range devices), especially via Bluetooth, and/or are wirelessly connected to each other via a local network (Local Area Network). In this way, as a computing device for example an existing PC may be used that performs processing of the information on the transponders and provides the memory unit. Moreover, the disposal bin may be installed distant from the computing device, for example in a kitchen, whereas the computing device is placed at a different site, such as for example an office room.

Preferably, the read-out device comprises at least three antennas. In order to assure that all transponders located in the receiving space may be detected, the use of at least three antennas is of special advantage.

Preferably, the read-out device is configured to read RFID transponders, furthermore preferably passive RFID transponders. RFID units as an established solution are especially useful for non-contact reading of stored information for realization of the present invention and are characterized by low price and high availability. Furthermore, passive RFID units may also be read without a separate power supply.

It is furthermore preferred that the computing device is connected to a public network and may exchange data with a vending server, preferably via a Web service. Thus, based on the identification of the article disposed of, an ordering procedure may instantaneously be performed.

Furthermore, in the context of the invention, a method for reordering goods is provided, which preferably uses a disposal system according to the invention and comprises the following steps:

reading identification data from one or more transponders that are attached to one or more articles, wherein reading is done while being deposited in a disposal bin or when they are already present in the disposal bin;

transmitting the read identification data to a computing device;

identifying said one or more articles by way of the identification data received by the computing device;

matching an inventory list stored in a memory unit of the computing device to said one or more identified articles;

creating an order list from one or more entries of the inventory list;

transmitting the order list to a vending server via a public network, preferably via a Web service.

The method according to the invention makes use of the fact that a change of the inventory in the household due to the consumption of goods is accompanied by disposal of the associated packages or articles. The detection of consumed goods thus is simplified, since by way of the method according to the invention, the user is not required to register goods after consumption or to manually order it. Articles disposed of are automatically detected with the method according to the invention, are assigned to an inventory list and from this inventory list an order list is generated, by means of which ordering procedures may be initiated, without requiring the user to trace the inventory or to tediously register each consumed product individually. For this, user-defined criteria may be used to make decisions on when an ordering procedure is to be initiated and which goods and in which quantity are to be reordered. This frees the user from the tedious job to manually check the inventory in the household and to replenish consumed goods.

In one embodiment of the method according to the invention reading is done at a predetermined point of time and/or in preset intervals. Reading may for example be performed on a daily base.

In another embodiment of the method according to the invention, during reading only one transponder is read, wherein reading is done at a point of time before the transponder enters a receiving space of the disposal bin. It is thereby assured that the inventory list is up-to-date at any point of time. In case that the disposal system according to the invention, is furthermore utilized, as described above, to segregate the household garbage disposed-of and to identify articles with valuable components, the identification step that is required for assigning the disposed-of article may simultaneously be utilized for updating the inventory list, thus making reorder of goods significantly easier.

The articles to be disposed of may be household garbage, especially (empty) packages. The articles may thus be (empty) containers. The shape of the articles may be circular, cylindrical or box-shaped. The volume of the individual articles, especially the empty containers, may be between 10 and 200 ml. The diameter of the article to be disposed of may be about 5 to 30 cm.

The associated disposal bin that is useful for receiving such household garbage, may have a volume between 30 and 500 L, especially between 50 L and 150 L, according to the invention. In order to be able to deposit household garbage in the disposal bin, the diameter of the opening of the disposal bin may be between 10 and 50 cm, especially between 20 and 40 cm.

Other embodiments of the invention will arise from the dependent claims.

### BRIEF DESCRIPTION OF THE DRAWINGS

In the following, the invention will be described by way of embodiments, which are explained in more details by way of the figures, wherein:

FIGS. 1 and 2 are a schematic view of a disposal system according to a first embodiment, in which the detection of the article in the disposal bin is performed;

FIGS. 3 and 4 are a schematic view of a disposal system according to a second embodiment, in which the detection of deposited articles is performed while being deposited;

FIGS. 5 and 6 are a schematic view of a disposal system according to a third embodiment, in which the disposal bin has a locking element, the actuator of which simultaneously activates the read-out device;

FIGS. 7 and 8 are a schematic view of a disposal system according to a fourth embodiment, in which the disposal bin has several receiving spaces, making the disposal system suitable for automated waste segregation.

In the following description, equal reference numerals will be used for equal parts.

### DETAILED DESCRIPTION

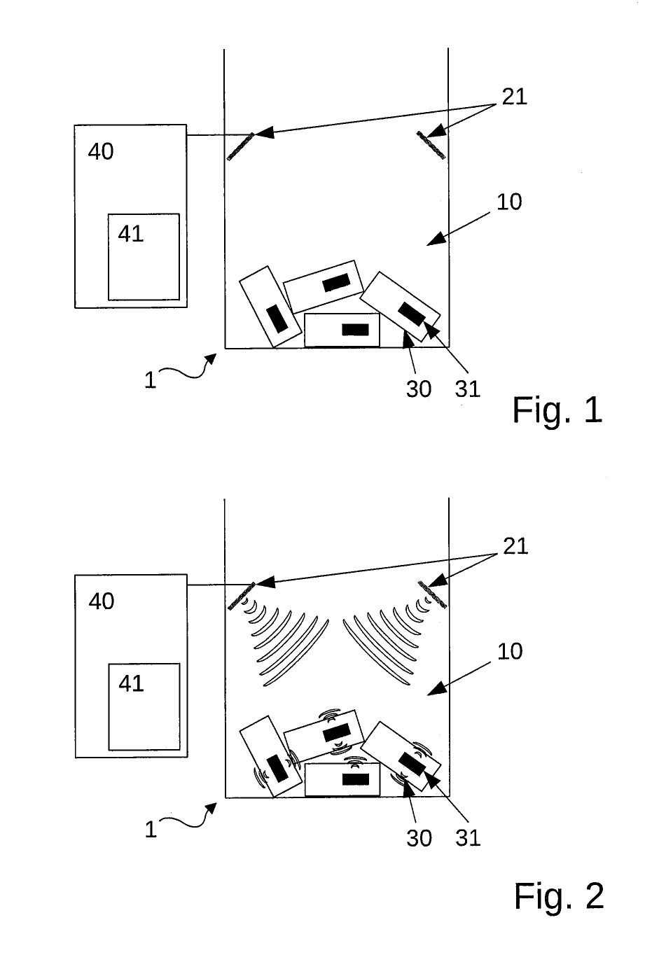

FIG. 1 shows a schematic view of a disposal system according to the invention in an embodiment, in which the disposal system comprises a disposal bin 1, which confines a receiving space 10. The disposal bin 1 has a volume of 100 L, in order to be suitable for receiving conventional household garbage such as empty packages. The disposal bin 1 has an opening at the top to be able to receive conventional waste generated in the household.

According to FIG. 1, there are several articles 30 in receiving space 10, each of which is provided with a transponder 31. Herein, the transponders 31 are passive RFID transponders that can be read in a non-contact manner. In FIG. 1, the articles 30 are represented, merely illustrative, in a box-shaped manner.

In order to allow reading the transponders 31, a read-out device 21 is mounted in the interior of the disposal bin 1 that is represented in FIG. 1 as two RFID antennas. To assure detection of the entire zone of the receiving space 10 and read-out of all transponders 31 located therein, irresepective of their orientation, the read-out device 21 may comprise more than two antennas, the orientation of whom within the disposal bin 1 may be different from that shown in FIG. 1. In order to furthermore assure that during a reading procedure only articles are read that are present in the receiving space 10, the disposal bin 1 is made of metal. Thus, the receiving space 10 is enclosed by electrical conductive surfaces shielding it against the surroundings.

The read-out device 21 is connected to a computing device 40. The connection is realized wirelessly (via Bluetooth, WLAN, etc.). The computing device 40 receives the data that was read by the reading device 21 from the transponders 31. A reading procedure is schematically shown in FIG. 2. By way of the data received an inventory list is maintained that represents the articles 30 that are present in the receiving space 10, and is stored on a memory unit 41 of the computing device 40.

The point of time of a reading procedure may be preset by the user. The reading procedure may also be conducted at fixed time intervals, e.g. every 30 minutes or once a day.

With the disposal system shown it is possible to perform automated reorders of goods. For this, the computing device 40 is connected to the internet, by way of which connection to a vending server 50 is achievable. Login data required for this are deposited on memory unit 41. If a reading procedure takes place, all articles 30 present in the receiving space 10 are identified and an inventory list is created on the memory unit 41, as described above. From one or more entries of the inventory list the computing device 40 generates an order list. Generation of the order list may require manual interaction of a user. The order list generated by the computing device 40 is sent to the vending server 50 via a Web service.

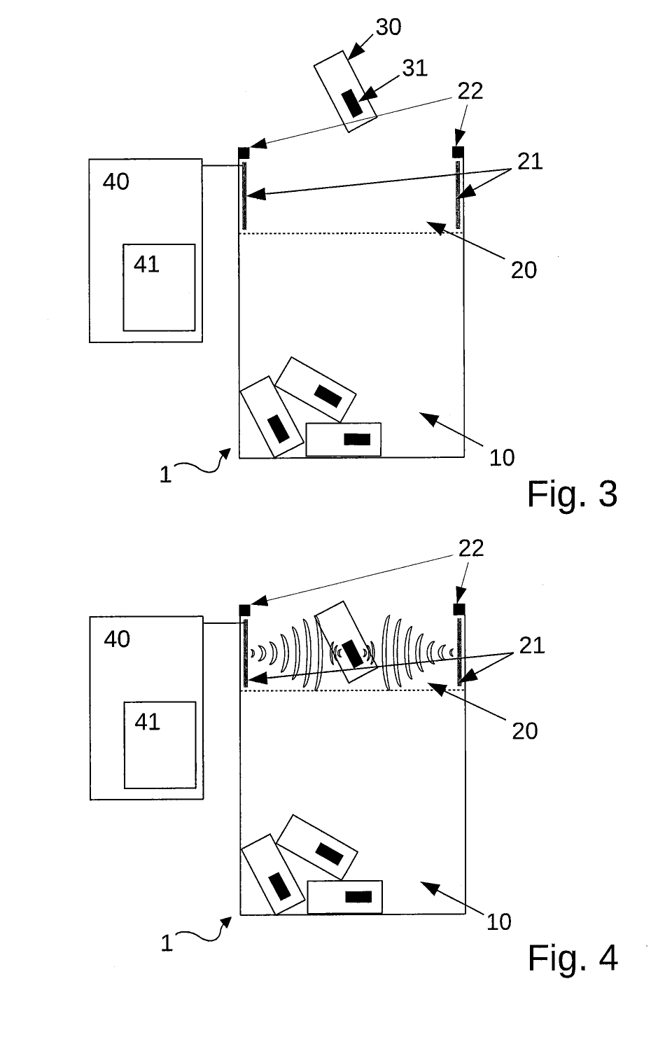

FIG. 3 shows a schematic view of a disposal system according to the invention in a second embodiment. In this embodiment the read-out device 21 is not arranged at the receiving space 10. A reading zone 20 that is passed by articles 30 when deposited in the opening of the disposal bin 1 is rather arranged above the receiving space 10. Again, the read-out device 21 is represented by two RFID antennas. The arrangement of the antennas is chosen such that exclusively the reading zone 20 is read, i.e. transponders in the receiving space 10 will not be detected. For this, the reading zone 20 is arranged in the upper third of the disposal bin.

If an article 30 is thrown into the disposal bin 1, it passes the reading zone 20 and the transponder 31 attached thereto is read by the read-out device 21. As in the first embodiment, the read data are transferred to the computing device 40 that identifies the consumed goods by way of the article 30 disposed of and updates the inventory list.

In the embodiment of FIGS. 3 and 4, an activation unit 22 is arranged at the top of the reading zone, which is formed of a light barrier or another motion-sensitive element and which monitors the entry of an article 30 into the reading zone 20. The motion-sensitive element serves as an activation unit 22 for the read-out device 21 and activates the read-out device 21 for a preset period of time every time an article 30 entering the disposal bin 1 is detected. For this, the period of time is selected such that the read-out device 21 is activated for a sufficiently long time to read the transponder 31 of the article 30 while the latter is in the reading zone 20. This may be seen schematically in FIGS. 3 and 4. As long as the article 30 is outside of the disposal bin 1, as it is show in FIG. 3, the read-out device 21 is deactivated. Upon entry of the article 30 into the reading zone 20 the activation unit 22 detects the movement of the article and activates the read-out device 21.

In this embodiment, during each deposition of an article 30 an update of the inventory list is performed, thus making it up-to-date at any point of time.

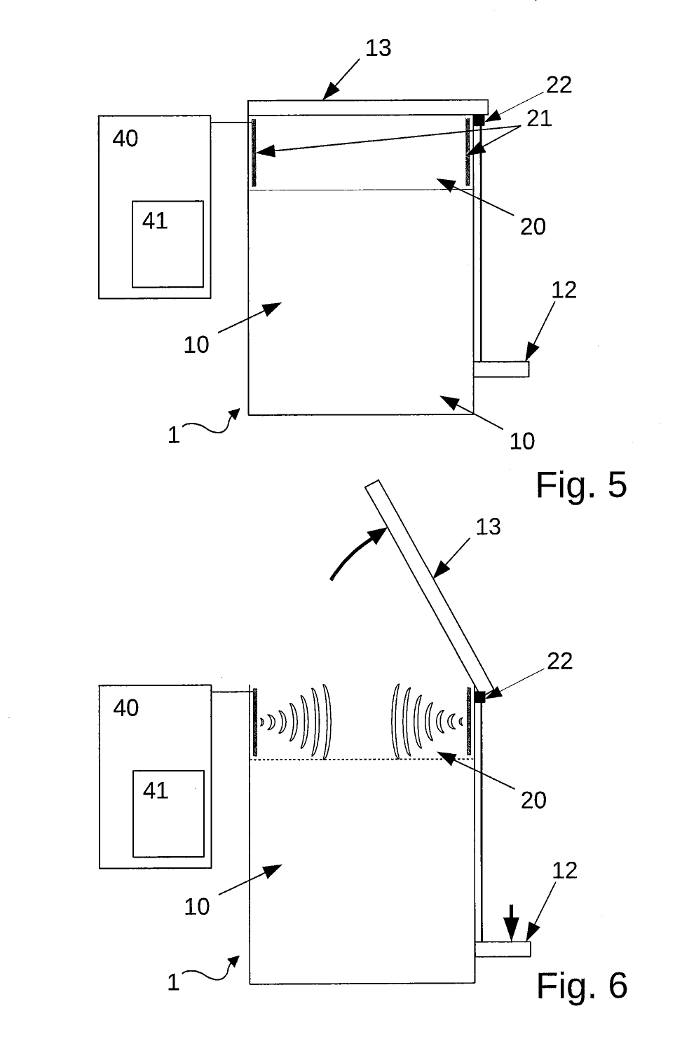

FIG. 5 shows a schematic view of a disposal system according to the invention in a third embodiment. The disposal bin 1 shown has a locking element 13 in the shape of a lid 13 that locks the deposit opening of the disposal bin 1. The lid 13 is coupled to a mechanically operable device 12, which in this case is a foot stepper 12. If a user presses the stepper 12 downwards, the lid 13 is tilted and the deposit opening of the disposal bin 1 is exposed, as it is shown in FIG. 6.

In this embodiment, the read-out device 21 is also arranged in a reading zone 20 above the receiving space 10 and, as in the second embodiment, is provided with an activation unit 22. In this embodiment, the activation unit 22 is not formed by a motion-sensitive element but is operatively coupled to the opening mechanism of the lid 13.

If the lid 13 is in the closing position, as it is shown in FIG. 5, the read-out device 21 is deactivated. The activation device 22 activates the read-out device 21 as soon as the stepper 12 is pushed downward and the lid 13 is in the open position, as it is shown in FIG. 6. Thus, a reading procedure is performed every time when the lid 13 of the disposal bin 1 opens, since, at that point of time, an article 30 is considered to be deposited.

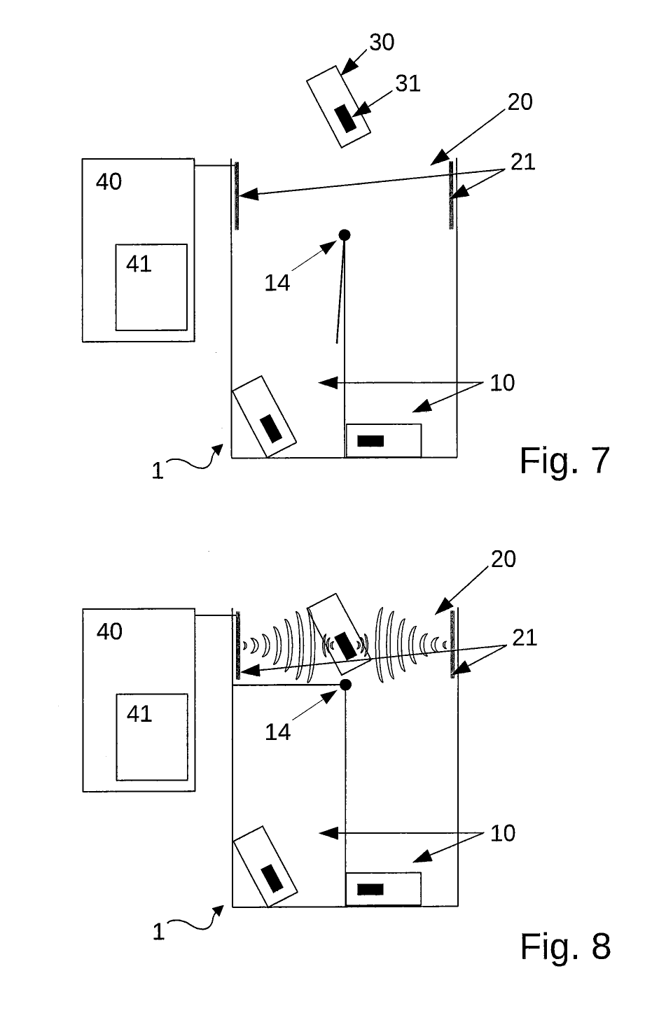

FIG. 7 shows a schematic view of a disposal system according to the invention in a fourth embodiment. In this embodiment, the disposal bin 1 has two receiving spaces 10 that are separated by a wall. Between the receiving spaces 10, an device 14 is mounted that is for assignment of deposited articles 30 to a receiving space 10 by opening one receiving space 10 and closing the other one. In the embodiment shown in FIGS. 7 and 8 the device 14 is a tiltable lid.

If an article 30 is deposited in the disposal bin and is read in the reading zone 20 the device 14 opens one of the receiving spaces 10 and closes the other receiving space 10, as it is shown in FIG. 8. It depends on the information stored on the transponder 31 which receiving space 10 will be opened. The deposited article 30 may thus exactly be assigned to one receiving space 10 by the information stored on its transponder 31 and may be deposited in it. This enables segregation of the articles 30 that were disposed of.

For this, different settings may be conceived. For example, in this way, articles 30 may be segregated according to the material from which they are made. In this setting, the disposal system according to the invention may perform an automated waste segregation without the user having to decide in which bin the articles from different materials are to be deposited.

However, it is also possible that information are stored on the transponder 31 that an article 30 contains valuable components such as rare earth metals. Articles having valuable components may thus be sorted out of the regular household garbage and may be transferred to specific recycling processes.

The invention was described by way of four specific embodiments. According to the invention, the individual embodiments may be combined in various ways. Moreover, various modifications are possible without departing from spirit of the invention.

In the embodiments described, the deposit opening of the disposal bin 1 always opens upwardly. However, it is also possible to provide the disposal bin 1 with a laterally arranged deposit opening. At a laterally arranged deposit opening, according to the second embodiment, a motion-sensitive activation unit 22 may be arranged that detects articles 30 entering the disposal bin 1. A lock 13 may also be provided. The activation unit 22 may furthermore be configured as a motion-sensitive element or may also be operatively coupled to an opening mechanism of the lock 13.

In the first embodiment the read-out device 21 is formed by two RFID antennas. However, the read-out device 21 may also be formed by antennas surrounding the disposal bin 1, each of which is formed of pairs of antennas intersecting each other at two intersecting points, wherein the intersecting points of different pairs of antennas are arranged spaced apart from each other. With this arrangement, transponders 31 in the disposal bin 1 may be read independently from their orientation. Furthermore, for improving the read-out characteristics it is possible to use antennas in the read-out device 21, by means of which rotating fields are generable, or to use antennas that are self-rotating. What is essential is that in the first embodiment all transponders 31 located in the disposal bin 1 are readable at all times.

According to the invention, the reading zone 20 is arranged above the receiving space 10 to be able to detect thrown-in articles 30. The reading zone 20 may also be configured to be movable, for example in the form of a drawer, which is mounted at top end of the disposal bin 1. The read-out device 21 may then be arranged in the drawer. Articles 30 to be disposed of are placed into the pulled-out drawer and read. The drawer is configured such that inserted articles 30 will fall into the receiving space 10 upon closing the drawer. Instead of a drawer, there may as well be provided a hinged drawer as a movable reading zone 20 having arranged therein the read-out device 21, which is horizontal-tiltably arranged at the disposal bin 1 and which allows insertion of articles 30 in the open position, wherein upon tilting to the closing position the read-out device 21 is activated and in the closing position the read article 30, from the hinged drawer, falls into the receiving space 10. What is essential according to the invention is simply that the reading zone 20 is arranged above the receiving space 10 and the read-out device 21 is configured such that only the article 30 currently disposed of is recorded. The read-out device 21, at a movable reading zone 20, is advantageously activated whenever the movable reading zone 20 is displaced from an open position to a closing position.

In the fourth embodiment, the device 14 is described as a lid, whereas other configurations of this device 14 are also conceivable. What is essential is simply that the device 14 opens a receiving space 10, so that deposited articles 30 are specifically assignable to receiving spaces 10.

The information read from the transponders 31 is used for identification of the articles 30 disposed of. Specifically, this information may be stored as a product code on the transponder 31, in particular as an electronic product code (EPC). The EPC is an internationally used and standardized key and code system and facilitates distinct assignment of articles. Entries in the inventory list may consist of the identified item, or may consist of the electronic product code, or both types of information may be stored. Furthermore, a time stamp may be stored with every entry.

According to the invention, the inventory list corresponds to the articles 30 present in the disposal bin 1. The inventory list contains all articles 30 present in the disposal bin 1, but a preselected inventory list may be maintained as well by way of the identified items that only accounts for goods for which automated reordering of goods is to be performed. The inventory list may be reset upon emptying the disposal bin 1.

An ordering procedure may manually be initiated by the user, or may be executed automatically at different points of time. An ordering procedure may also be initiated when items maintained in the inventory list reach a predetermined value. It is also possible to store a stock list maintaining the stock of goods which are on stock in the household. Since the inventory list corresponds to the articles 30 present in the disposal bin 1, i.e. corresponds to consumed goods, the stock list may be matched to the inventory list. Ordering procedures may be initiated, when the stock of specified goods has been reduced to a predetermined value or has been depleted.

The order list is generated from the entries of the inventory list. At this point, it is possible to send item names to the vending server 50. Alternatively, the order list may also consist of the EPCs stored in the inventory list, or the computing device 40 determines supplier-specific order numbers by way of item names or EPCs and therefrom creates the order list.

According to the invention, updating the inventory list may also be omitted. Especially when the disposal bin 1 according to the fourth embodiment comprises multiple receiving spaces 10 the read goods information may be used for automated waste segregation. For this, information on which materials the disposed-of articles 30 consist of is either stored on the transponders 31 or the computing device 40 determines the materials by way of identified goods. If the articles 30 disposed of are sorted by way of the read information, furthermore, sorting out of articles that contain valuable components, such as rare earth metals, may be performed.

### LIST OF REFERENCE NUMBERS

1 disposal bin
10 receiving space
12 mechanically operable device
13 locking element
14 device for selectively assigning a receiving space
20 reading zone
21 read-out device
22 activation unit
30 article
31 transponder
40 computing device
41 memory unit
50 vending server

1. A disposal system, comprising
a disposal bin having at least one receiving space for receiving articles, especially packages or items, which are provided with a transponder,
a computing device having a memory unit for storing an inventory list,
a read-out device connected to the computing device for reading data, in particular identification data, which is stored on the transponders,
wherein the read-out device is configured and arranged at the disposal bin such that the data on the transponders, which are attached to articles deposited in the disposal bin are readable,
wherein the computing device is in communicative connection with the reading device to update the inventory list stored in the memory unit based on the data read from the reading device.

2. The disposal system according to claim 1,
characterized in that,
the disposal bin comprises a receiving space and the read-out device is configured and arranged such that all transponders present in the receiving space are readable.

3. The disposal system according to claim 1,
characterized in that,
the disposal bin has an opening, at and/or surrounding which the read-out device is arranged such that transponders are readable upon depositing articles in the disposal bin.

4. The disposal system according to claim 3,
characterized in that,
the read-out device comprises an activation unit, which is configured to activate the read-out device.

5. The disposal system according to claim 3,
characterized in that,
the one activation unit is arranged for capturing the opening and is configured as a motion-sensitive element.

6. The disposal system according to claim 4,
characterized in that:
an actuator for releasing an/the opening is operatively connected to the activation unit such that the read-out device is activated when the actuator is operated.

7. The disposal system according to claim 3,
characterized by:
at least two receiving spaces and
an apparatus for selectively assigning deposited articles, which is configured such that the article are assignable to and are introducible into exactly one of the receiving spaces, depending on the information read from the transponder.

8. The disposal system according to claim 1,
characterized in that,
the read-out device and the computing device are connected to each other via a (short range) wireless communication (short range devices), especially via Bluetooth, and/or are wirelessly connected to each other via a local network (Local Area Network).

9. The disposal system according to claim 1,
characterized in that,
the read-out device comprises at least three antennas.

10. The disposal system according to claim 1,
characterized in that,
the read-out device is designed to read RFID transponders, especially passive RFID transponders.

11. The disposal system according to claim 1,
characterized in that,
the computing device is connected to a public network and may exchange data via a vending server, preferably via a Web service.

12. A method for reordering goods, in particular using a system according to claim 1, comprising the following steps:
reading identification data from one or more transponders, which are attached to one or more articles, wherein reading is performed while said articles are being deposited in a disposal bin or when said articles are already present in the disposal bin;
transmitting the read identification data to a computing device;
identifying the one or more articles by way of the identification data received from the computing device;
matching an inventory list stored in a memory unit of the computing device with the one or more identified articles;
creating an order list from one or more entries of the inventory list;
transmitting the order list via a public network to a vending server, preferably via a web service.

13. The method according to claim 12,
characterized in that,
reading is performed at a predetermined point of time and all transponders present in a receiving space of the disposal bin are read.

14. The method of claim 12,
characterized in that,
upon reading, only one transponder is read, wherein reading is performed at a point of time before the transponder enters a receiving space of the disposal bin.
